(19) United States
(12) Patent Application Publication
(10) Pub. No.: US 2007/0188485 A1
(43) Pub. Date: Aug. 16, 2007

(54) Image formation processing simulation apparatus and image formation processing simulation method

(75) Inventor: Kiyoshi Yasukawa, Saitama (JP)

Correspondence Address: SUGHRUE-265550, 2100 PENNSYLVANIA AVE. NW, WASHINGTON, DC, 20037-3213, US

(73) Assignee: FUJI XEROX CO., LTD., Minato-ku (JP)

(21) Appl. No.: 11/478,674

(22) Filed: Jul. 3, 2006

(30) Foreign Application Priority Data
Feb. 14, 2006 (JP) 2006-035978

(51) Int. Cl. G06T 15/00

(52) U.S. Cl. 345/419

(57) ABSTRACT

An image formation processing simulation apparatus includes: an acceptance unit that accepts image data targeted for image formation processing in an image formation processing device; a performing unit that performs a simulation of image formation processing for which the image data in the image formation processing device is targeted using the image data; a failure management unit that determines whether or not failure occurs in the simulation; and an output unit that outputs information about a result of the determination by the failure management unit.

### CROSS-REFERENCE TO RELATED APPLICATION

This application claims priority under 35 USC 119 from Japanese Patent Application No. 2006-035978 filed on Feb. 14, 2006, the disclosure of which is incorporated by reference herein.

### FIELD

The present invention relates to an apparatus and a method for simulating image formation processing in an image formation processing device, and particularly to an image formation processing simulation apparatus and an image formation processing simulation method for taking measures against failure occurring in image formation processing.

### BACKGROUND

Conventionally, when failure occurs in image formation processing (print processing) in an image formation processing device (printer device), a user of the image formation processing device took measures against the failure by reporting the failure to a repair service representative or reporting information about the failure to a service center.

However, in the conventional art described above, a person capable of taking measures is limited to the repair service representative, or a report from the user to the service center may be insufficient, so that the user could not necessarily obtain proper measures against the failure promptly.

### SUMMARY

An image formation processing simulation apparatus includes: an acceptance unit that accepts image data targeted for image formation processing in an image formation processing device; a performing unit that performs a simulation of image formation processing for which the image data in the image formation processing device is targeted using the image data; a failure management unit that determines whether or not failure occurs in the simulation; and an output unit that outputs information about a result of the determination by the failure management unit.

### BRIEF DESCRIPTION OF THE DRAWINGS

In the accompanying drawings:

FIG. 1 is an explanatory diagram of a main configuration of an image formation processing simulation system according to the embodiment;

FIG. 2 is a block diagram showing a main configuration of an image formation processing simulation apparatus according to the embodiment;

FIG. 3 is a functional block diagram showing main processing performed by a control unit of the image formation processing simulation apparatus according to the embodiment;

FIG. 4 is a flow diagram showing one example of processing performed by a terminal device according to the embodiment;

FIG. 5 is a flow diagram showing one example of simulation processing related to failure occurring in print processing performed by the control unit of the image formation processing simulation apparatus according to the embodiment;

FIG. 6 is an explanatory diagram showing one example of a failure database according to the embodiment;

FIG. 7 is a flow diagram showing one example of simulation processing related to failure of print processing performed by the control unit of the image formation processing simulation apparatus according to the embodiment; and

FIG. 8 is an explanatory diagram showing another example of a failure database according to the embodiment.

### DETAILED DESCRIPTION

An image formation processing simulation system (hereinafter called “a simulation system”) including an image formation processing simulation apparatus (hereinafter called “a simulation apparatus”) according to one embodiment of the invention will be described below. In addition, in the present embodiment, the case of using a printer device for performing print processing as an image formation processing device for performing image formation processing will be described as an example.

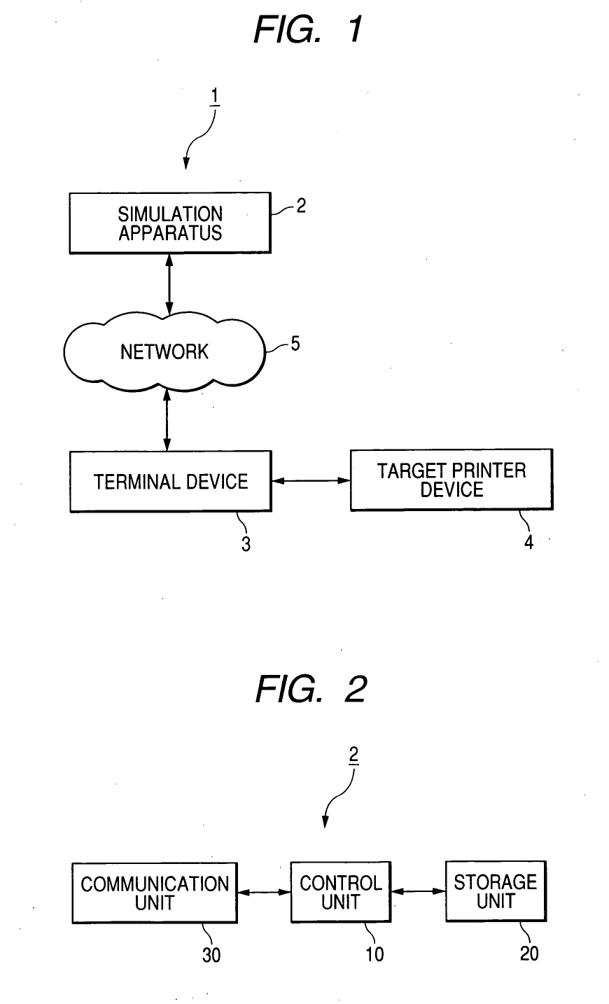

FIG. 1 is an explanatory diagram of a main configuration of a simulation system 1. The simulation system 1 includes a simulation apparatus 2, a terminal device 3 and a target printer device 4 as shown in FIG. 1.

The simulation apparatus 2 and the terminal device 3 are respectively connected to a network 5, and can send and receive data mutually through the network 5. Also, the terminal device 3 is connected to the target printer device 4 so that data can be sent and received mutually. According to a command accepted from the terminal device 3, this target printer device 4 forms an image on a predetermined paper medium and performs print processing for outputting the paper medium on which the image is formed.

In addition, in the embodiment, the network 5 is implemented by the Internet and the simulation apparatus 2 is implemented by a part of the web server computer and the terminal device 3 is implemented by a personal computer carried by a user of the simulation system 1.

An outline of one example of simulation service offered by this simulation system 1 will be described herein. In this simulation system 1, the terminal device 3 first outputs data (hereinafter called “processing target data”) targeted for print processing to the target printer device 4 based on instructions inputted from a user to an input device such as a keyboard or an operation panel which the terminal device 3 includes, and makes the target printer device 4 perform print processing for which the processing target data is targeted.

Further, this terminal device 3 monitors whether or not failure occurs in print processing performed by the target printer device 4. Then, when the failure occurs in print processing performed in the target printer device 4, the terminal device 3 accesses a web site related to simulation service offered by the simulation apparatus 2 through the network 5 and also sends information (hereinafter called “failure related information”) about the failure and processing target data targeted for the print processing in which the failure occurs to the simulation apparatus 2.

The simulation apparatus 2 accepting the access from the terminal device 3 performs a simulation of print processing for which processing target data accepted from the terminal device 3 is targeted, that is, a simulation (hereinafter called “a reproduction simulation”) of reproducing print processing in which failure occurs in the target printer device 4 using the same program (hereinafter called “a target program”) as that used in print processing in which failure occurs in the target printer device 4 pinpointed by the failure related information accepted from the terminal device 3.

Also, this simulation apparatus 2 performs a simulation (hereinafter called “a change simulation”) of print processing for which processing target data accepted from the terminal device 3 is targeted using a program (hereinafter called “a change program”) in which at least a part of the target program is changed.

Then, the simulation apparatus 2 determines whether or not failure similar to the failure occurring in the target printer device 4 occurs in each of the reproduction simulation and the change simulation. As a result of this determination, for example, when failure similar to the failure occurring in the target printer device 4 occurs in the reproduction simulation and the failure does not occur in the change simulation, the simulation apparatus 2 sends information about the change program used in print processing targeted for the change simulation to the terminal device 3. That is, in this case, for example, a screen of a simulation result to the effect that occurrence of failure can be avoided is displayed by using the change program in print processing in the target printer device 4 for a display which the terminal device 3 includes. As a result of this, a user can promptly obtain proper measures against failure, for example, replacing the target program which the target printer device 4 includes with the change program.

FIG. 2 is a block diagram showing a main configuration of the simulation apparatus 2. The simulation apparatus 2 has a control unit 10, a storage unit 20 and a communication unit 30 as shown in FIG. 2.

The control unit 10 is implemented by, for example, a CPU (Central Processing Unit) and operates according to a program (software) stored in the storage unit 20. The concrete contents of processing performed by this control unit 10 will be described below in detail.

The storage unit 20 can be implemented by, for example, RAM (Random Access Memory), ROM (Read Only Memory) or a hard disk. A program executed by the control unit 10 is stored in this storage unit 20. Also, this storage unit 20 operates as work memory for holding data used in processing performed by the control unit 10.

The communication unit 30 can be implemented by, for example, a network board. This communication unit 30 is connected to the network 5 and accepts data from the terminal device 3 through the network 5 and also outputs the accepted data to the control unit 10. Also, this communication unit 30 sends data inputted from the control unit 10 to the terminal device 3 through the network 5. In addition, this communication unit 30 can also be implemented by, for example, a parallel port or a serial port such as a USB (Universal Serial Bus).

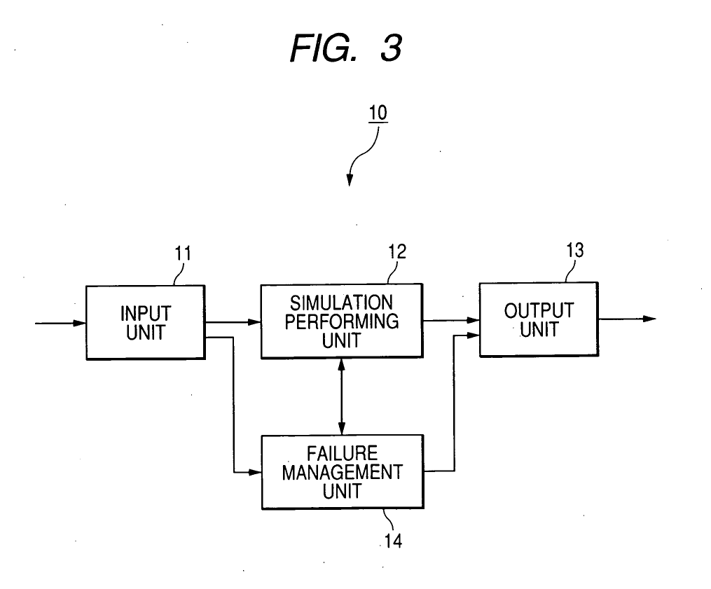

Next, the contents of processing performed by the control unit 10 will be described in detail. FIG. 3 is a functional block diagram showing main processing performed by the control unit 10. The control unit 10 functionally includes an input unit 11, a simulation performing unit 12, an output unit 13 and a failure management unit 14 as shown in FIG. 3.

The input unit 11 accepts processing target data from the terminal device 3. This processing target data is data generated in a data format capable of being used in print processing performed by the target printer device 4. That is, this processing target data is, for example, PDL data described by a predetermined PDL (Page Description Language) capable of being processed by the target printer device 4, and is a print job including an image data portion representing an image (including a text portion such as a character string, a graphic portion such as line drawing, a photographic portion, etc.) to be formed on a predetermined medium (for example, a paper medium) by print processing and a header portion for specifying print conditions such as layout of the image on the medium or the number of media and standards of the medium. The input unit 11 outputs this accepted processing target data to the simulation performing unit 12.

Also, the input unit 11 accepts image data (hereinafter called “original image data”) representing an image to be formed on the medium by print processing used in generation of the processing target data from the terminal device 3. This original image data is, for example, application data before rasterization generated using application software (for example, software for text creation or software for graphic drawing) installed in the terminal device 3. In addition, in this case, the processing target data is generated as a print job related to the original image data by converting the original image data into PDL data by, for example, print driver software corresponding to the target printer device 4 installed in the terminal device 3. The input unit 11 outputs this accepted original image data to the failure management unit 14.

Also, the input unit 11 accepts failure related information from the terminal device 3. This failure related information is information for pinpointing the contents or a kind of failure occurring in the target printer device 4. That is, the failure related information includes, for example, identification information (hereinafter called “a failure code”) previously associated with failure which may occur in the target printer device 4. This failure code is held in, for example, the target printer device 4. In this case, the target printer device 4 sends a failure code associated with the occurring failure among plural held failure codes to the terminal device 3 when failure occurs in print processing performed. The input unit 11 accepts the failure related information including the failure code notified from this target printer device 4 from the terminal device 3. The input unit 11 outputs this accepted failure related information to the failure management unit 14.

Also, the input unit 11 accepts information (hereinafter called “print condition information”) about a condition of print processing in which failure occurs in the target printer device 4. This print condition information includes, for example, information (hereinafter called “target printer pinpointing information”) for pinpointing the target printer device 4 in which the failure occurs. This target printer pinpointing information is information for pinpointing a kind of the target printer device 4 and includes, for example, a number or a character string for pinpointing a product name, model identification information, a manufacturer of the target printer device 4.

Also, this print condition information includes, for example, information (hereinafter called “target program pinpointing information”) for pinpointing a program used in print processing in which failure occurs in the target printer device 4. This target program pinpointing information includes, for example, information for pinpointing a version or a kind of firmware for print processing which the target printer device 4 includes. The terminal device 3 may acquire the print condition information by two-way communication with the target printer device 4 or may accept an input of the print condition information from a user. In addition, this target program pinpointing information may include, for example, information for pinpointing application software used in generation of original image data or printer driver software etc. used in generation of a print job based on the original image data. The input unit 11 outputs this accepted print condition information to the simulation performing unit 12.

The simulation performing unit 12 performs a simulation for simulating print processing for which processing target data in the target printer device 4 is targeted based on the print condition information and the processing target data accepted from the input unit 11. That is, the simulation performing unit 12 first determines a condition of print processing targeted for simulation based on the print condition information.

Concretely, the simulation performing unit 12 determines a target program used in the print processing based on target program pinpointing information included in print condition information as one of conditions of print processing targeted for reproduction simulation. Here, a print condition data table in which with respect to plural candidate printer devices which the simulation apparatus 2 can target for simulation, information (hereinafter called “candidate printer pinpointing information”) for pinpointing each of the candidate printer devices is mutually associated with information (hereinafter called “candidate program pinpointing information”) for pinpointing a candidate program capable of being used in print processing in each of the candidate printer devices is held in the storage unit 20. Also, each of the candidate programs pinpointed by each of the candidate program pinpointing information is held in this storage unit 20.

Then, the simulation performing unit 12 determines a candidate program pinpointed by the candidate program pinpointing information matched with the target program pinpointing information by referring to this print condition data table as a target program. This target program is, for example, the same firmware as firmware used in print processing in which failure occurs in the target printer device 4 actually.

Also, the simulation performing unit 12 determines a change program used in the print processing based on a print condition data table, target printer pinpointing information and target program pinpointing information included in print condition information as one of conditions of print processing targeted for change simulation. Here, a part of the plural candidate programs held by the storage unit 20 is a program of a new version in which at least a part of another program is modified.

Therefore, when a change program of the latest version in which a target program is improved is held in the storage unit 20, the simulation performing unit 12 determines the change program as a program used in print processing targeted for change simulation. That is, the simulation performing unit 12 determines a program after improvement in which at least a part of the target program in which creation timing is newer than that of a target program pinpointed by target program pinpointing information among candidate programs pinpointed by candidate program pinpointing information associated with the same candidate printer pinpointing information as target printer pinpointing information in a print condition data table is modified as a change program. This change program is, for example, firmware of the latest version in which a fault of a part of the firmware used in print processing in which failure occurs in the target printer device 4 actually is modified.

Then, the simulation performing unit 12 performs a reproduction simulation for simulating print processing for which processing target data is targeted using a target program. Here, the print processing which the simulation performing unit 12 targets for simulation includes data analysis processing for analyzing an image data portion and a header portion included in the processing target data and generating configuration data for being supplied to bitmap expansion, image drawing processing for rasterizing the configuration data and generating page data made of bitmap data, and output processing for forming an image on a medium based on the page data and also delivering the medium. That is, the simulation performing unit 12 performs a reproduction simulation for simulating the data analysis processing, a reproduction simulation for simulating the image drawing processing and a reproduction simulation for simulating the output processing using the target program.

Also, the simulation performing unit 12 performs a change simulation for simulating print processing for which processing target data is targeted using a change program. That is, the simulation performing unit 12 performs a change simulation for simulating data analysis processing, a change simulation for simulating image drawing processing and a change simulation for simulating output processing using the change program. The simulation performing unit 12 outputs a result of simulation to the output unit 13 and the failure management unit 14.

The failure management unit 14 determines whether or not failure occurs in a simulation of print processing performed by the simulation performing unit 12, and outputs information about a result of the determination to the output unit 13. That is, the failure management unit 14 determines whether or not processing stops during the processing or predetermined failure occurs in each of the processing steps of, for example, data analysis processing, image drawing processing and output processing among print processing targeted for simulation. This failure management unit 14 determines that failure occurs when processing stops during print processing.

Also, the failure management unit 14 determines that failure occurs, for example, when any event included in a failure database occurs in a performing simulation by referring to the failure database, in which events about failure which may occur in a simulation are enumerated, held by the storage unit 20.

Also, in the case of determining that failure occurs in a simulation, the failure management unit 14 examines a cause of the occurring failure and outputs information about a result of the examination to the output unit 13. That is, for example, when failure in which processing stops during print processing occurs, the failure management unit 14 pinpoints the portion related to a stop of the processing among the program used in the print processing as a cause of the failure.

Also, for example, when failure in which print processing stops and the portion related to a stop of the processing among the program used in the print processing are previously associated and held in a failure database, the failure management unit 14 refers to the failure database and pinpoints a stop place of the program associated with the failure as a cause place of the failure occurring in the simulation. In addition, the cause of the failure pinpointed by the failure management unit 14 is not limited to one cause, and plural cause candidates can also be pinpointed.

Also, when failure which may occur in the target printer device 4 and measures to solve the failure which may occur are associated and held in a failure database held by the storage unit 20 and a cause of failure occurring in a simulation is pinpointed, the failure management unit 14 refers to the failure database and determines the measures associated with the pinpointed cause as measures against the failure occurring in the simulation.

Also, the failure management unit 14 determines whether or not failure occurs in a change simulation using a change program and when the failure does not occur in the change simulation, information about the change program is generated and is outputted to the output unit 13. That is, when failure occurring in the target printer device 4 does not occur in the change simulation, the failure management unit 14 generates information about measures capable of avoiding the failure by using the change program used in the change simulation in print processing in the target printer device 4, and outputs the information to the output unit 13.

Also, when the simulation performing unit 12 performs a reproduction simulation and a change simulation, the failure management unit 14 determines whether or not failure occurring in print processing in the target printer device 4 occurs in each of the reproduction simulation and the change simulation and when this failure occurs in the reproduction simulation and does not occur in the change simulation, information about a change program used in the change simulation is generated as information about measures against the failure.

In addition, for example, when a failure code database for associating failure codes with the contents of failure which may occur in the target printer device 4 is held in the storage unit 20 in a manner similar to the information which the target printer device 4 includes, the failure management unit 14 refers to the failure code database and pinpoints which failure code the failure occurring in a simulation is associated with, and when the pinpointed failure code matches with a failure code included in failure related information accepted from the input unit 11, it is decided that the same failure as the failure occurring in the target printer device 4 occurs in the simulation.

Also, when information about the same failure as the failure occurring in the simulation is not included in a failure database held by the storage unit 20, the failure management unit 14 performs update processing for newly registering the information about the failure in the failure database. That is, when measures capable of avoiding the failure occurring in the simulation can be pinpointed, the failure management unit 14 performs update processing for associating the occurring failure with the measures and newly registering the failure and the measures in the failure database as information about the failure.

Also, the failure management unit 14 registers the contents of failure when measures against the failure cannot be pinpointed and are not known, or registers a cause of the failure when the measures are pinpointed in the failure database. Then, when a cause or measures is newly pinpointed with respect to failure in which a cause or measures has already has been registered in the failure database but is not pinpointed yet, the failure management unit 14 updates the failure database by newly associating the newly pinpointed cause or measures with the failure.

Also, when failure occurring in the target printer device 4 occurs in a reproduction simulation and does not occur in a change simulation, the failure management unit 14 performs update processing for associating information about a change program used in the change simulation with the failure and holding the information in a failure database as information about measures against the failure.

Also, the failure management unit 14 compares data (hereinafter called “reference data”) in which original image data accepted from the input unit 11 is rasterized with data (hereinafter called “print data”) accepted as a result of simulation from the simulation performing unit 12, and outputs information about a result of the comparison to the output unit 13. That is, in this case, the failure management unit 14 performs bitmap expansion of original image data and generates reference data made of bitmap data. Also, this failure management unit 14 accepts print data made of the bitmap data generated as a result of simulation of print processing for which a print job generated based on this original image data is targeted from the simulation performing unit 12.

Then, this failure management unit 14 compares a bitmap image (hereinafter called “a reference image”) represented by reference data with a bitmap image (hereinafter called “a print image”) represented by print data, and determines identity between the reference image and the print image based on a predefined criterion, and outputs a result of the determination to the output unit 13. Here, the failure management unit 14 matches a result of color matching between reference data and print data by, for example, rasterizing original image data by color conversion processing similar to color conversion processing performed in a simulation by the simulation performing unit 12. Concretely, this failure management unit 14 rasterizes original image data using, for example, the same color conversion table as that used in the case where the simulation performing unit 12 performs bitmap expansion based on a print job in a simulation. Then, the failure management unit 14 determines identity between a reference image and a print image by determining whether or not there is a difference between reference data and print data in a bitmap format. Also, the failure management unit 14, for example, determines whether or not a difference between a reference image and a print image is within a predetermined range and when the difference is within the predetermined range, it may be decided that the reference image matches with the print image. Also, the failure management unit 14, for example, mutually compares edges extracted from each of the reference image and the print image and when the edges are the same or a difference between the edges is within a predetermined range, it may be decided that the reference image matches with the print image. Also, when information for pinpointing failure occurring in an image formed on a medium or information for pinpointing a place in which each of the failures occurs is included in failure related information accepted from the input unit 11, the failure management unit 14 may read out a criterion (for example, a predetermined range for determining the extent of difference) previously associated with the occurring failure among criteria held in the storage unit 20 based on the failure related information and may decide whether or not a reference image matches with a print image based on the criterion read out. In addition, in this case, the failure related information includes, for example, information for pinpointing the occurring failure such as a missing character, failure of a pattern (for example, failure of hatching or half-tone dot meshing processing), failure of color in an image formed on a medium (for example, failure of superimposition processing), or information (for example, coordinate information for pinpointing a position in which failure of an image or a medium occurs) for pinpointing a place in which each of the failures occurs. This failure related information is inputted to the terminal device 3 by, for example, a user. Also, when this failure management unit 14 determines that a reference image is not identical with a print image, information etc. about a cause or the contents of its difference are outputted to the output unit 13.

The output unit 13 outputs information etc. about measures against failure accepted from the failure management unit 14 and a result of simulation accepted from the simulation performing unit 12 to the terminal device 3 through the communication unit 30. As a result of this, the information etc. about measures against failure or this result of simulation are displayed on a display of the terminal device 3.

Also, the output unit 13 notifies a user to ask an input necessary to perform a simulation. That is, the output unit 13 displays a user interface screen for making a request so as to send processing target data, original image data, failure related information, print condition information, etc. to the simulation apparatus 2 on the terminal device 3. Also, when failure is solved in a change simulation, the output unit 13 displays a screen for recommending that a program which the target printer device 4 includes should be updated to a change program used in the change simulation as measures against the failure on the terminal device 3.

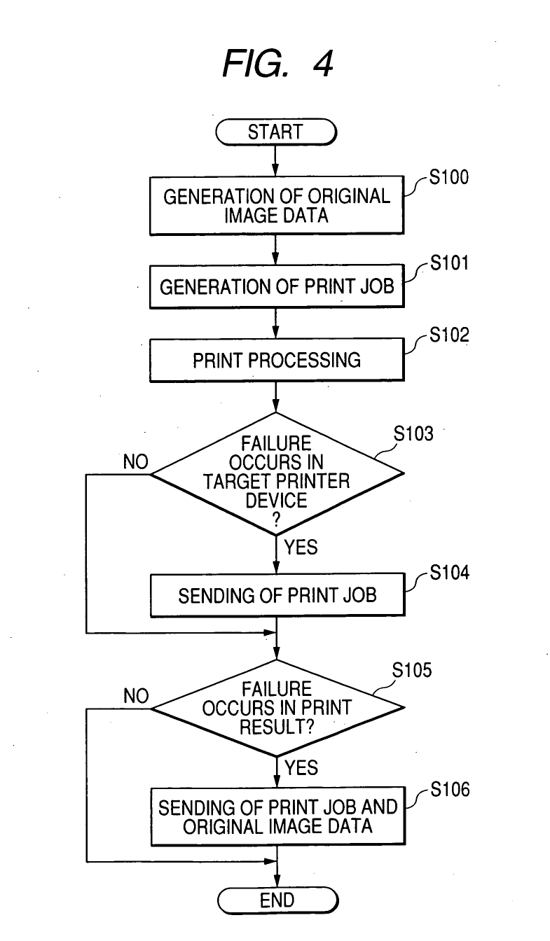

Next, a flow of processing performed in the simulation system 1 will be described. FIG. 4 is a flow diagram showing a main flow of one example of processing performed by the terminal device 3. As shown in FIG. 4, according to instructions from a user, the terminal device 3 activates application software and generates original image data representing an image to be formed on a paper medium (S100). Further, the terminal device 3 activates a printer driver and converts this original image data into PDL data and generates a print job capable of being processed by the target printer device 4 (S101) Then, the terminal device 3 outputs this print job to the target printer device 4 and makes the target printer device 4 perform print processing (S102). In addition, in this case, the terminal device 3 holds the print job in a spooler which the terminal device 3 includes.

While this target printer device 4 performs print processing, the terminal device 3 determines, for example, whether or not failure occurs in the print processing (S103). Here, the terminal device 3 determines that the failure occurs, for example, when notification of a failure code is accepted from the target printer device 4 (Yes in S103). In this case, the terminal device 3 generates failure related information about the failure and sends the failure related information together with the print job held in the spooler to the simulation apparatus 2 (S104). Also, when the failure does not occur (No in S103), the terminal device 3 proceeds to processing S105.

Also, when a paper medium on which an image is formed is outputted as a result of the print processing in the target printer device 4, the terminal device 3 determines whether or not an input from a user is done with respect to failure of the image formed on the paper medium (S105). Here, when an input in which failure occurs in the print processing is received from the user (Yes in S105), the terminal device 3 sends the print job held in the spooler, the original image data (original image data generated in processing S100) used in generation of the print job and the failure related information about the failure to the simulation apparatus 2 (S106), and ends the processing. In addition, when the failure does not occur in a print result (No in S105), the terminal device 3 ends the processing. In addition, before the processing is ended, the terminal device 3 deletes the print job held in the spooler which the terminal device 3 includes.

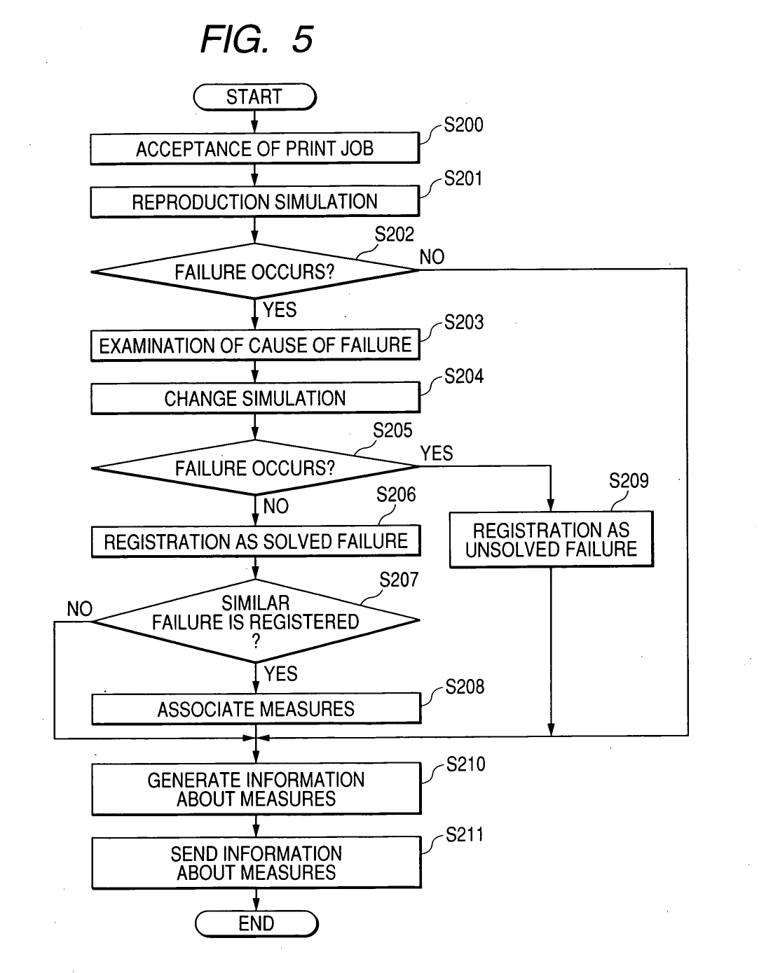

FIG. 5 is a flow diagram showing a main flow of one example of simulation processing related to failure occurring in print processing in the target printer device 4 performed by the control unit 10 of the simulation apparatus 2. As shown in FIG. 5, the input unit 11 accepts a print job used in print processing together with instructions to perform a simulation of the print processing in which failure occurs from the terminal device 3 (S200). The simulation performing unit 12 performs a reproduction simulation of print processing for which the print job accepted from the terminal device 3 is targeted using the same target program as that used in the print processing in which this failure occurs (S201). Then, the failure management unit 14 determines whether or not failure occurs in this reproduction simulation (S202). Here, when the failure occurs (Yes in S202), the failure management unit 14 examines a cause of the occurring failure (S203).

Also, in this case, the simulation performing unit 12 performs a change simulation of print processing for which the print job targeted in the reproduction simulation is targeted using a change program which is a modified version of a target program (S204). Then, the failure management unit 14 determines whether or not failure also occurs in this change simulation (S205).

Here, when the failure does not occur in the change simulation (No in S205), the failure management unit 14 registers this failure together with information about measures by using the change program in a failure database held by the storage unit 20 as the solved failure (S206). Also, in this case, the failure management unit 14 further determines whether or not failure similar to this solved failure has already been registered in the failure database (S207), and when the similar failure has been registered (Yes in S207), update processing of the failure database in which the information about measures by using the change program is newly associated with the similar failure is performed (S208).

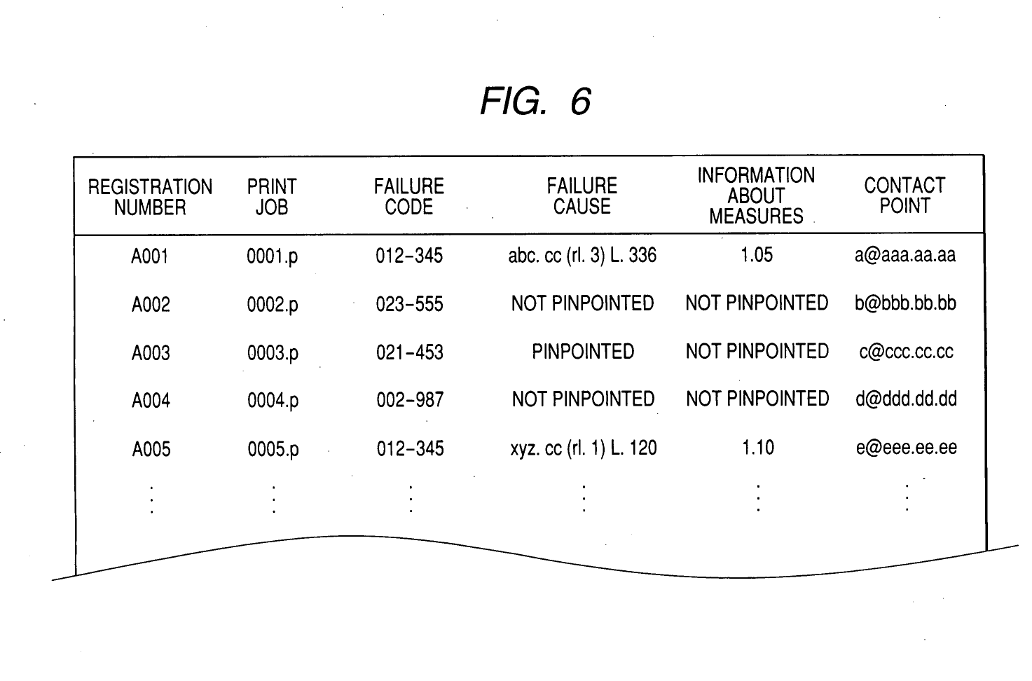

Here, one example of the failure database held by the storage unit 20 is shown in FIG. 6. As shown in FIG. 6, a registration number allocated to each of the failures, information for pinpointing a print job targeted for print processing in which each of the failures occurs, a failure code for pinpointing each of the failures, information indicating a cause of each of the failures, information about measures against each of the failures and a contact point (mail address or web address, etc.) of the case where each of the failures occurs are mutually associated and held in this failure database. In addition, as information indicating a cause of failure in which print processing stops during the processing, information (for example, “abc.cc(r1.3)L.356”) for pinpointing a version and a kind of firmware used in the print processing and a stop place of the firmware is held in the failure database shown in this FIG. 6. Also, information (for example, “1.05”) for pinpointing a new version of firmware capable of performing print processing without occurrence of the failure is held as information about measures against this failure. Also, in a part of the plural failures registered in the failure database, a cause or measures against the failure are not pinpointed yet (“not pinpointed” in FIG. 6), or the measures are not pinpointed though the failure is pinpointed. Also, for example, when print jobs targeted for print processing differ even for failures pinpointed by the same failure code “012-345”, causes of the failures or measures against the failures may differ mutually.

Then, the failure management unit 14 generates information about measures against failure occurring in the target printer device 4 based on results of the reproduction simulation and the change simulation (S210). That is, for example, when failure is not reproduced in the reproduction simulation (No in S202), the failure management unit 14 generates information to the effect that there is a high possibility that the failure occurring in the target printer device 4 is not caused by at least a program used in the reproduction simulation and has a hardware problem, for example, mechanical failure (sensor failure etc.) in the target printer device 4. Also, for example, when failure is not solved in the change simulation (Yes in S205), the failure management unit 14 registers the failure in the failure database as unsolved failure (S209) and also generates information to the effect that means for solving the failure is not found yet. Also, for example, when failure occurring in the target printer device 4 similarly occurs in the reproduction simulation but does not occur in the change simulation, the failure management unit 14 generates information to the effect that the failure is solved by updating a program used in print processing in the target printer device 4 to a change program. Then, the failure management unit 14 sends this information about measures to the terminal device 3 and ends the processing. In addition, when use of a change program results in measures of failure, the output unit 13 displays an operation screen for recommending acquisition of the change program on a display of the terminal device 3. In this case, for example, a user can download the change program held by the simulation apparatus 2 through the network 5 by inputting information to the effect that acquisition of the change program is desired according to guidance of this operation screen to the terminal device 3. As a result of this, the user can solve the failure promptly by installing this downloaded change program in the target printer device 4.

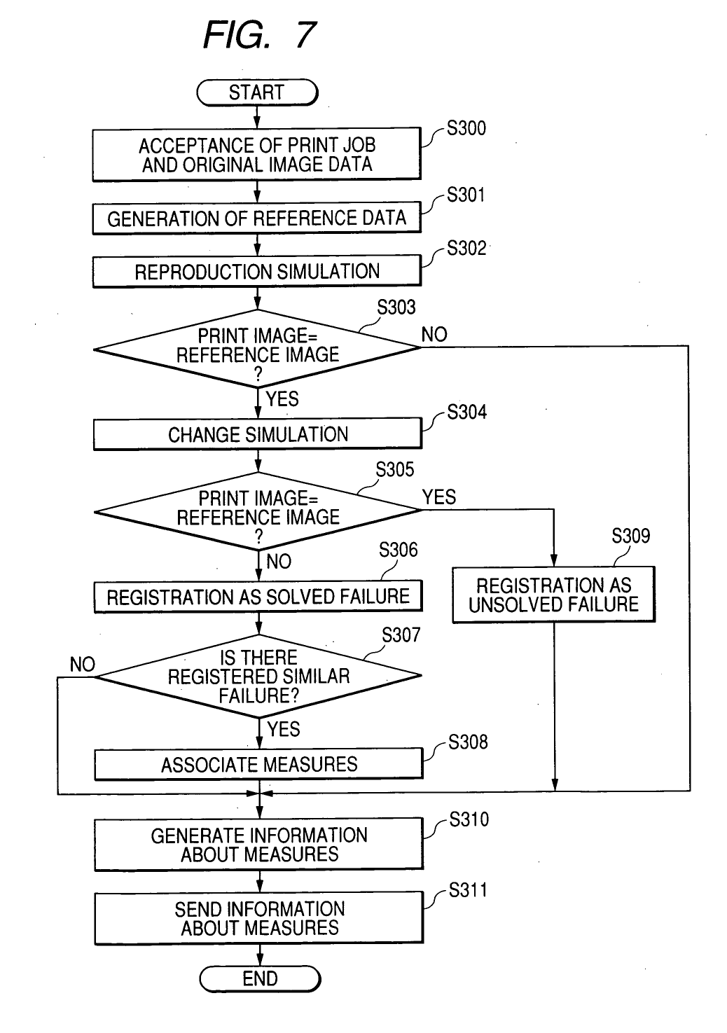

FIG. 7 is a flow diagram showing a main flow of one example of simulation processing related to failure of a result of print processing in the target printer device 4 performed by the control unit 10 of the simulation apparatus 2. As shown in FIG. 7, the input unit 11 accepts a print job used in print processing and original image data used in generation of the print job together with instructions to perform a simulation of the print processing in which failure occurs in a print result from the terminal device 3 (S300). The simulation performing unit 12 rasterizes this original image data and generates reference data made of bitmap data (S301). Also, this simulation performing unit 12 performs a reproduction simulation of print processing for which the print job accepted from the terminal device 3 is targeted using the same target program as that used in the print processing in which this failure occurs (S302). Then, the failure management unit 14 determines whether or not there is a difference between a reference image represented by reference data directly generated from the original image data and a print image represented by print data generated as a result of the print processing related to this reproduction simulation based on a predefined criterion (S303).

Here, when the failure management unit 14 determines that there is the difference between the reference image and the print image generated by the print processing related to the reproduction simulation (Yes in S303), that is, determines that failure occurs in a print result, the simulation performing unit 12 performs a change simulation of print processing for which the print job targeted in the reproduction simulation is targeted using a change program which is a modified version of a target program (S304). Then, the failure management unit 14 determines whether or not there is a difference between a reference image represented by reference data and a print image represented by print data generated as a result of the print processing related to this change simulation based on a predefined criterion (S305).

Here, in the case of determining that there is not the difference between the reference image and the print image generated by the print processing. related to the change simulation (No in S305), the failure management unit 14 registers this failure together with information about measures by using the change program in a failure database held by the storage unit 20 as the solved failure (S306). Also, in this case, the failure management unit 14 further determines whether or not failure similar to this solved failure has already been registered in the failure database (S307), and when the similar failure has been registered (Yes in S307), update processing of the failure database in which the information about measures by using the change program is newly associated with the similar failure is performed (S308).

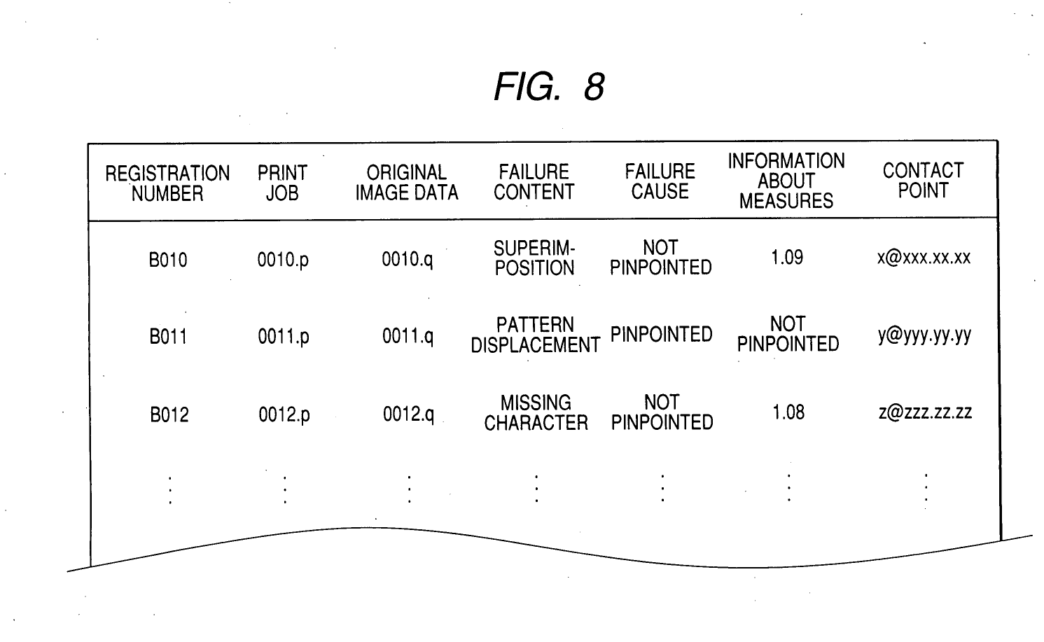

Here, one example of the failure database held by the storage unit 20 is shown in FIG. 8. As shown in FIG. 8, a registration number allocated to each of the failures, information for pinpointing a print job targeted for print processing in which each of the failures occurs, information for pinpointing original image data used in generation of each of the print jobs, information indicating the contents of each of the failures, information indicating a cause of each of the failures, information about measures against each of the failures and a contact point of the case where each of the failures occurs are mutually associated and held in this failure database. In addition, the failure database shown in this FIG. 8 includes failure of superimposition of an image, displacement of a pattern (for example, hatching) included in an image, a missing character included in an image, etc. as failure causes.

Then, the failure management unit 14 generates information about measures against failure occurring in the target printer device 4 based on results of the reproduction simulation and the change simulation (S310). That is, for example, when failure is not reproduced in the reproduction simulation (No in S303), the failure management unit 14 generates information to the effect that there is a high possibility that the failure occurring in the target printer device 4 is not caused by at least a program used in the reproduction simulation and has a hardware problem, for example, mechanical failure in the target printer device 4. Also, for example, when failure is not solved in the change simulation (Yes in S305), the failure management unit 14 registers the failure in the failure database as unsolved failure (S309) and also generates information to the effect that means for solving the failure is not found yet. Also, for example, when failure occurring in the target printer device 4 similarly occurs in the reproduction simulation but does not occur in the change simulation, the failure management unit 14 generates information to the effect that the failure is solved by updating a program used in print processing in the target printer device 4 to a change program. Then, the failure management unit 14 sends this information about measures to the terminal device 3 and ends the processing.

Also, the control unit 10 may perform maintenance processing of a failure database in which the unsolved failure in which measures are not obtained yet is registered. That is, in this case, even when concrete measures cannot be presented to a user as a result of simulation (for example, the case of No in processing S205 of FIG. 5 or the case of No in processing S305 of FIG. 7), thereafter, the control unit 10 performs an additional simulation with respect to the unsolved failure registered (for example, the unsolved failure registered in processing S209 in FIG. 5 or processing S309 in FIG. 7) and when measures are newly obtained as a result of the additional simulation, information about the obtained measures is offered to a user. Concretely, for example, when a new change program is held in the storage unit 20, the simulation performing unit 12 performs a change simulation for which a print job associated with the unsolved failure is targeted using the change program, and the failure management unit 14 determines whether or not failure occurs in the change simulation. Here, when the failure does not occur, the failure management unit 14 determines that measures are newly obtained with respect to the unsolved failure in which measures are not obtained until then, and generates information about the measures by using the change program, and associates the unsolved failure with the information about the measures and registers the unsolved failure in the failure database. Then, the output unit 13 outputs this information about the measures to the terminal device 3 and thereby, a user can thereafter acquire information about new measures which have become apparent by maintenance processing of the failure database performed in the simulation apparatus 2 with respect to the failure which was not solved in the past. In addition, for example, when measures are obtained in simulation processing for which failure of the contents similar to unsolved failure is targeted, the control unit 10 may perform maintenance processing for determining whether or not the unsolved failure can be solved by the measures. In this case, the simulation performing unit 12 performs a simulation of the unsolved failure using a change program related to measures against similar failure, and the failure management unit 14 sends information about measures to use the change program to the terminal device 3 when failure does not occur in the simulation. Also, the control unit 10 may perform maintenance processing periodically according to, for example, a predefined schedule.

In addition, the invention is not limited to the examples described above. For example, the simulation apparatus 2 may be configured so as to accept original image data from the terminal device 3 and generate processing target data based on the original image data and perform a simulation of print processing for which the generated processing target data is targeted. That is, for example, the simulation apparatus 2 includes printer driver software designed for the target printer device 4 or application software used in generation of the original image data, and the simulation performing unit 12 generates PDL data from the original image data which the input unit 11 accepts from the terminal device 3 using the printer driver software and performs a simulation of print processing using the PDL data.

Also, for example, processing target data which the simulation apparatus 2 accepts from the terminal device 3 is not limited to the data actually used in the target printer device 4. That is, for example, a user sends a print job generated in the terminal device 3 to the simulation apparatus 2 and makes the simulation apparatus 2 perform a simulation and thereby, information as to whether or not failure occurs in the case of performing print processing for which the print job is targeted in the target printer device 4 and also information about measures to avoid the failure can be previously obtained. Also, a destination to which the simulation apparatus 2 sends information about measures against the failure is not limited to the terminal device 3 in which data or information about the failure is sent to the simulation apparatus 2 and may be, for example, an electronic mail address of a user of the terminal device 3.

Also, the terminal device 3 which can access the simulation apparatus 2 is not limited to one terminal device, and the simulation apparatus 2 can perform a simulation at the request of plural computers etc. connected to the network 5. Also, the network 5 is not limited to the Internet and can also be implemented by, for example, a LAN (Local Area Network). Also, the terminal device 3 can be implemented by a portable terminal device such as a PDA (Personal Digital Assistance) or a portable telephone. Also, an image formation processing device included in the simulation system 1 is not particularly limited as long as the device is a device for performing image formation processing based on inputted data, and can also be implemented by, for example, a facsimile machine, a copying machine such as a copier, or a scanner device for optically reading an image formed on a medium.

What is claimed is:

1. An image formation processing simulation apparatus comprising:
an acceptance unit that accepts image data targeted for image formation processing in an image formation processing device;
a performing unit that performs a simulation of image formation processing for which the image data in the image formation processing device is targeted using the image data;
a failure management unit that determines whether or not failure occurs in the simulation; and
an output unit that outputs information about a result of the determination by the failure management unit.

2. The image formation processing simulation apparatus according to claim 1, wherein, when determined that failure occurs in the simulation, the failure management unit examines a cause of the occurring failure, and
wherein the output unit outputs information about a result of the examination.

3. The image formation processing simulation apparatus according to claim 2, further comprising a storage unit that stores a database for associating failure which may occur in the image formation processing device with measures against the failure,
wherein the failure management unit determines measures against failure occurring in the simulation based on the database and a result of the examination, and
wherein the output unit outputs information about the determined measures.

4. The image formation processing simulation apparatus according to claim 1, wherein the performing unit performs a simulation of image formation processing for which the image data is targeted using a change program in which at least a part of the program used in image formation processing for which the image data is targeted in the image formation processing device is changed, and
wherein the failure management unit determines whether or not failure occurs in a simulation using the change program and when the failure does not occur, the failure management unit generates information about the change program, and
wherein the output unit outputs the information about the change program.

5. The image formation processing simulation apparatus according to claim 4, wherein the acceptance unit accepts the image data targeted for image formation processing in which failure occurs in the image formation processing device, and
wherein the performing unit performs a reproduction simulation of image formation processing for which the image data is targeted using a program used in the image formation processing in which the failure occurs in the image formation processing device and also performs a change simulation of image formation processing for which the image data is targeted using the change program, and
wherein the failure management unit determines whether or not the failure occurs in each of the reproduction simulation and the change simulation and when the failure occurs in the reproduction simulation and the failure does not occur in the change simulation, the failure management unit generates information about the change program.

6. The image formation processing simulation apparatus according to claim 5, wherein the failure management unit associates the failure with information about the change program and holds the failure and the information when the failure occurs in the reproduction simulation and the failure does not occur in the change simulation.

7. The image formation processing simulation method comprising:
accepting image data targeted for image formation processing in an image formation processing device;
performing a simulation of image formation processing for which the image data in the image formation processing device is targeted using the image data;
determining whether or not failure occurs in the simulation; and
outputting information about a result of the determination.
